(19) United States
(12) Patent Application Publication
(10) Pub. No.: US 2002/0038782 A1
(43) Pub. Date: Apr. 4, 2002

(54) Plate-and -frame type membrane module system with inserted durable balls using vortex flow

(76) Inventors: Jae-Jin Kim, Seoul (KR); Jong-Pyo Kim, Kwangmyong-si (KR)

Correspondence Address: PENNIE AND EDMONDS, 1155 AVENUE OF THE AMERICAS, NEW YORK, NY, 100362711

(21) Appl. No.: 09/923,472

(22) Filed: Aug. 6, 2001

(30) Foreign Application Priority Data
Aug. 5, 2000 (KR) 2000-45444

(51) Int. Cl. B01D 25/00

(52) U.S. Cl. 210/231; 210/227; 210/416.1; 210/453; 210/456

(57) ABSTRACT

The present invention is directed to a plate-and-frame type membrane module inserted durable balls using vortex flow, and the membrane module can reduce concentration polarization, cake or gel layer and membrane fouling which generally occur in processes using plate-and-frame type membrane. Thus, the use of a membrane module according to the present invention can prolong the period for cleaning of a membrane module and the exchange period of a membrane module, as well as maximize a passing amount without decreasing a quality of permeate.

### BACKGROUND OF THE INVENTION

1. Field of the Invention

The present invention is directed to a plate-and-frame type membrane module with inserted durable balls. More particularly, the present invention provides a new plate-and-frame type membrane module with inserted durable balls operating in a vortex flow mode, which can reduce the permeation-resistant layer so as to minimize the amount of decreased permeate flux and to maximize the service life of a membrane in plate-and-frame type membrane processes, regardless of the type of membrane processes, such as reverse osmosis, ultrafiltration, microfiltration, etc. Said membrane processes always accompany deleterious phenomena which cause a decline in the permeate flux; for example, concentration polarization which occurs near the membrane surface, cake or gel layers deposited on the membrane surface, and membrane fouling formed in the membrane, when they are used to separate one or more solutes, such as salts, ions, etc., in solution, to eliminate macromolecules or colloidal materials, such as yeast, proteins, polymers, etc., or to fractionate according to molecular weight or size.

2. Description of the Prior Art

At present, separation, purification and/or fractionation processes utilizing membrane technology have widely been used in a variety of industries. Membrane processes provide the advantage of effectively separating solution or mixture while using only a small amount of energy and do not generate additional waste after separation. Membrane processes allow for a simple operation to easily establish a desired objective. Membrane configurations may be classified into hollow fiber, tubular, spiral-wound and plate-and-frame type membranes. In general, plate-and-frame type membranes have been restricted in their applications because they are difficult to modulize and have a low packing density when compared to hollow fiber and spiral-wound membranes.

Various types of membrane modules have been developed in order to improve the disadvantages of a plate-and-frame type membrane module. Dorr-Oliver, DDS, Inc., GKSS, Rhone-Poulenc, etc., have developed membranes that were designed to have a narrow flow path to increase their packing density and, also, to have various flow paths to decrease membrane fouling. Such plate-and-frame type membranes cannot easily be applied in separation or fractionation of the highly concentrated solutions required in various industry fields due to their narrow flow path. And since a decrease in concentration polarization or membrane fouling depends on the flow of feed fluid and modification of the flow path, the membranes are restricted in their ability to treat such problems (see U.S. Pat. Nos. 4,613,436, 4,715,955, 4,990,230, 5,082,549 and 5,624,555).

Methods to reduce such concentration polarization or membrane fouling include an approach in which a fine insoluble gas is incorporated into the flow of a feed fluid. Korean Patent Application No. 96-14033 discloses a method for concentrating emulsified waste oils, wherein an air vent is installed between a feed tank and a pump to introduce air, whereby concentration polarization or membrane fouling can be reduced. It is known that an introduction of air reduces the concentration polarization that forms near the membrane surface by forming bubbles and irregular fluctuation within the membrane module. However, this method may cause damage to the pump due to pump cavitation by air, and limit the ability to reduce concentration polarization since bubbles are apt to converge on the center of a membrane module by means of a pinch effect within the membrane module.

A similar type of membrane apparatus is disclosed, for example, in R. Ghosh, Q. Li and Z, Cui, Fractionation of BSA and Lysozyme Using Ultrafiltration: Effect of Gas Sparging, AIChE J., Vol. 44, No. 1, pp. 61-67(1998), and Z. F. Cui, K. I. T. Wright, Flux Enhancements with Sparging in Downwards Crossflow Ultrafiltration: Performance and Mechanism, Journal of Membrane Science, Vol. 117, No. 1-2, pp. 109-116(1996).

In Japanese Patent Open-Laid Publication No. 66-209706, balls were inserted to clean the inside of a reverse osmosis membrane used for drainage facilities in an atomic energy plant. This invention is further furnished with a feed apparatus to supply balls into the tubular membrane. However, such a feed apparatus has the disadvantage of being confined to a tubular membrane only, and it has a relatively complicated shape.

### SUMMARY OF THE INVENTION

Therefore, the present inventors continually researched this issue before discovering the present invention as a means of solving the problems of conventional techniques.

The present invention provides a new plate-and-frame type membrane module with inserted durable balls that can more effectively prevent cake layers or concentration polarization layers from forming on the membrane surface or within the membrane, which is the problem that accompanies membrane processes in order to maintain a high permeate flux. The instant invention enables long-term operating time, and can be easily used in high concentrations of solution.

It is an objective of the invention to provide a new type of a membrane module that can eliminate the formation of cake layers and concentration polarization so as to prolong the service life of a membrane and also to minimize the time required to clean the membrane in order to maximize permeation flux without reducing rejection efficiency.

The above and further objectives, characteristics and advantages of the invention can be fully understood through the following detailed description.

### BRIEF DESCRIPTION OF THE DRAWINGS

FIG. 1 is a schematic representation of a membrane to demonstrate the permeable performance of a membrane equipped with a membrane module according to the present invention.

FIGS. 2A, 2B and 2C are schematic representations of plate-and-frame type membrane module, a lower body, and an intermediate body including an inlet for a feed fluid, respectively.

FIG. 3 is a schematic representation of a laminated membrane module that laminates membrane modules.

FIG. 4A is a graph showing the permeation flux of a dead-end type, a vortex flow type and an inserted durable balls type according to the filtration time.

FIG. 4B is a graph showing a concentration rejection and a permeability for a feed fluid in the embodiment.

### DETAILED DESCRIPTION OF THE INVENTION

The objective of the present invention is achieved by inserting durable balls into the inside of a plate-and-frame type membrane module and fluctuating or rotating the balls by means of a rotatory force of feed fluids introduced while rotating, to eliminate cake and concentration polarization layers and, thus, maintain a high rejection efficiency and permeability.

More specifically, according to the present invention, when a plate-and-frame type membrane module with inserted durable balls is used to separate or fractionate solutions containing yeast, protein, starch, or dextran, this membrane module can reduce or diminish material boundary layers near the membrane surface or cake layer on the membrane surface, or prevent the formation of permeation-resistant layer in order to reduce the permeation flux of a membrane by fluctuating or rotating balls by means of the rotatory force of feed fluids introduced into the membrane module.

Further, a plate-and-frame type membrane module of the present invention can restrict a permeation-resistant layer in the process in which a concentration polarization layer or a cake layer is formed near the membrane surface when the membrane module fractionates a mixture of a wide range of molecular weight polymer material, different molecular weight proteins or a mixture of two or more solutes using ultrafilteration or microfiltration in accordance with the constant range of molecular weight, the kind of component or molecular size, or eliminates colloids, proteins, oil emulsion and etc. with ultrafilteration or microfiltration.

The present invention provides a plate-and-frame type membrane module using vortex flow, comprising

a single membrane module,

a rotatory feed fluid pipe to rotate feed fluids, while introducing said fluids through two inlets provided on opposing sides at the bottom of the membrane module,

a plurality of durable balls which are inserted into the module to eliminate cake or concentration polarization layers formed on the membrane surface by fluctuating or rotating them by influx of rotated feed fluids from the inlet into the module,

a pressure reduction-eliminating feed fluid pipe to remove pressure reduction within the module which is generated by the rotation of the feed fluid, and

a block net screen which is provided in an intermediate portion of the module or near a outlet of a concentrated fluid so as to prevent from being swept away the durable balls.

The present invention also provides a plate-and-frame type membrane module using vortex flow, comprising

a laminated membrane module,

a rotatory feed fluid pipe to rotate feed fluids, while introducing said fluids through two inlets provided on opposing sides at the bottom of the membrane module,

a distributor to uniformly provide the feed fluids from the rotated feed fluids pipe to each of a unit modules,

a plurality of durable balls which are inserted into the module to eliminate cake or concentration polarization layers formed on the membrane surface by fluctuating or rotating them by influx of rotated feed fluids from the inlet into the module, and

a block net screen which is provided in an intermediate portion of the module or near a outlet of a concentrated fluid so as to prevent from being swept away the durable balls.

Such a membrane according to the present invention will in more detail explain by attached figures for reference.

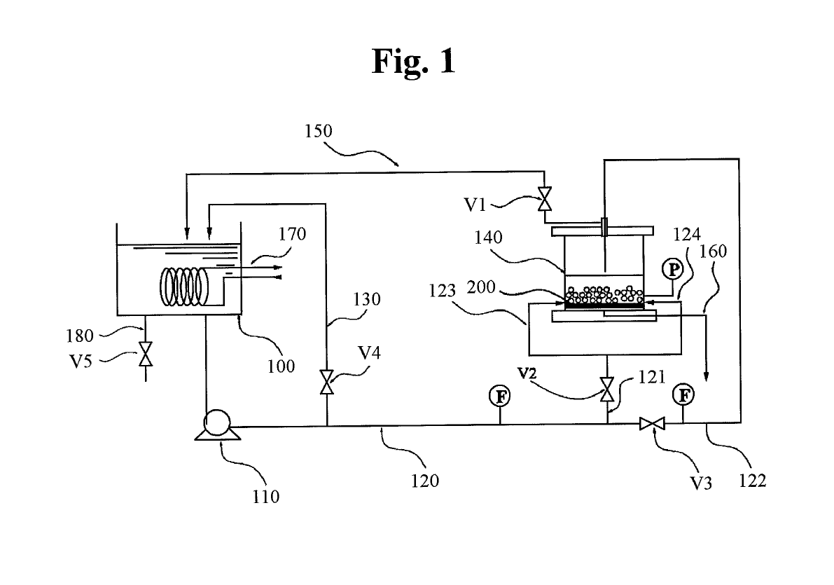

FIG. 1 shows a membrane system to demonstrate the permeation performance of a membrane equipped with a membrane module according to the present invention. More specifically, a membrane system according to the present invention stores material to be separated or fractionated, which is introduced from a process into a feed tank (100), and connects a thermostat (170) to the feed tank (100) to suitably maintain the temperature of the materials. Feed fluids also are transported into a membrane module (140) through a feed fluid pipe (120), and a flow meter (F) is installed to measure the feed flow rate before introducing them into the membrane module (140). Here, a pressure and flow rate regulator valve (V1, V4) can respectively be installed in a concentrated fluid pipe (150) and a by-pass pipe (130) to optionally set an operating mode. Permeates that are passed through a membrane (200) are discharged through a permeate fluid pipe (160), and concentrated fluids are circulated and concentrated into the feed tank through a concentrated fluid pipe (150) or a by-pass pipe (130) and is then discharged via outlet (180).

The present invention can use two types of modules, a single membrane module having a single unit, or a laminated membrane, in which the single membrane is laminated. The path providing feed fluids is slightly varied according to the type of module.

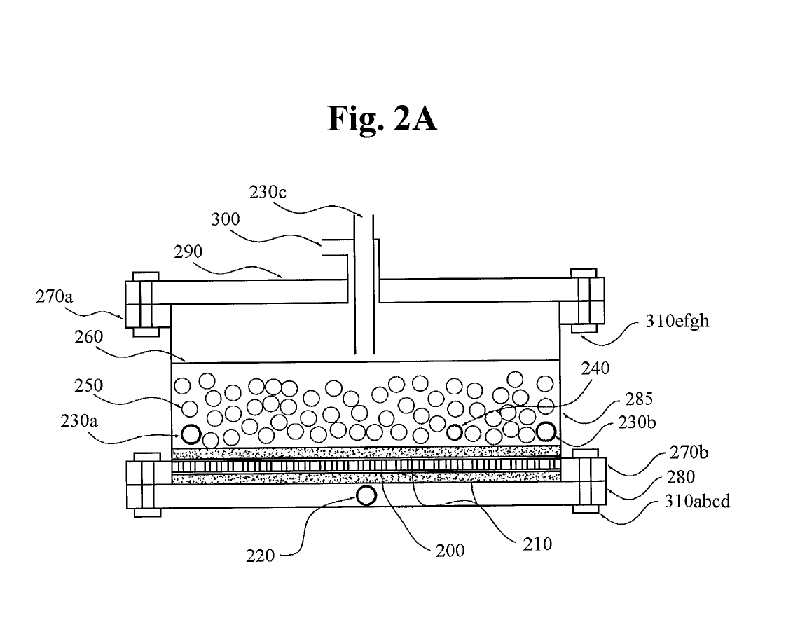

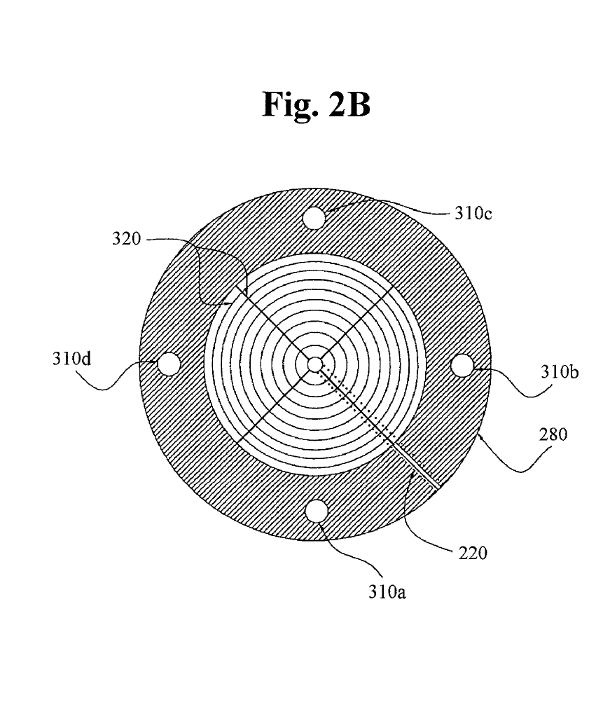

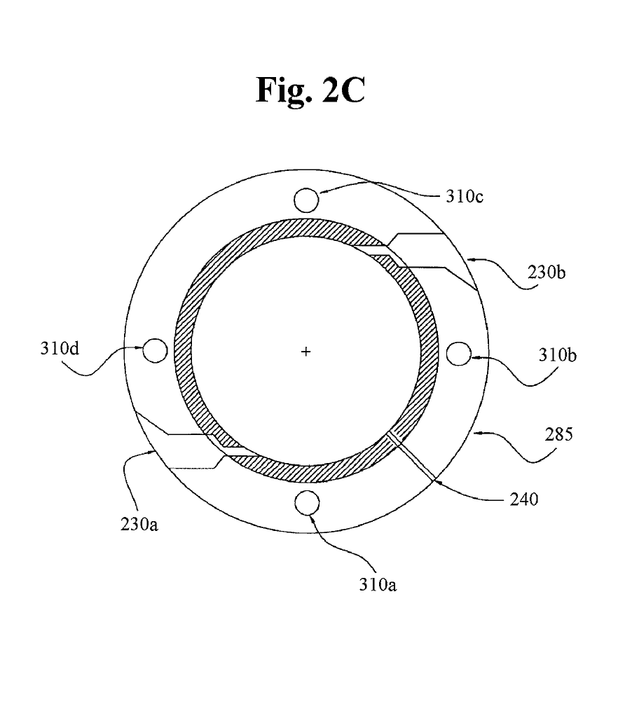

First, for a single membrane module (FIGS. 2A, 2B, 2C), when in a membrane module (see FIG. 1), feed fluids are introduced through a feed fluid pipe (120) into the membrane, they are branched into a rotated feed fluid pipe (121) to fluctuate or rotate the balls (250) and a pressure reduction-eliminating feed fluid (122) to eliminate pressure reduction in the center of the membrane module, and the rotated feed fluid pipe (121) is again branched into two feed fluid pipes (123 and 124). The flux of the feed fluids in the rotated feed fluid pipe (121) and the pressure reduction-eliminating feed fluid pipe (122) is controlled by a flux regulator valve (V2, V3) attached to each of the pipes. The driving pressure may be represented by means of a manometer (P) provided in the membrane module.

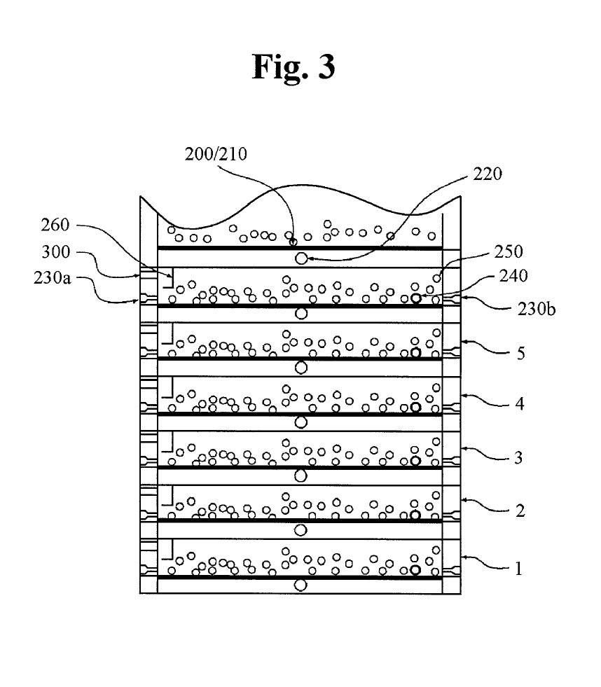

For a laminated membrane module (FIG. 3), a pressure reducing-eliminating feed pipe (122) is removed, but a distributor is installed on two feed fluid pipes (123 and 124) branched from the rotating feed fluids pipe (121) to uniformly supply feed fluids into each of the unit modules. The height of the module is minimized and a concentrated fluid outlet (300) is installed on the side to facilitate lamination of the unit module. The number of laminated unit modules is determined depending on the surface area of the membrane or the capacity of the feed pump to transport the feed fluids. Thus, the use of the laminated membrane module according to the present invention can increase the capacity of the membrane.

FIG. 2 shows a unit membrane module equipped with a membrane. FIG. 2B represents the lower body of a membrane, and FIG. 2C represents an intermediate body including an influx path of feed fluids. The membrane (200) has the upper and lower portions protected with a non-woven fabric or polymer mesh (210), and the upper non-woven fabric protects the membrane from the fluctuation of the balls, and the lower non-woven fabric from the operating pressure. A block net screen (260) is installed in the intermediate of a separation or near a concentrated fluid outlet (300) to prevent balls present in the module from being swept away. The module is tightened by a means of bolts/nuts (310abcd, 310efgh) to prevent a loss of pressure or feed fluids. As shown in FIG. 2B, an inducing groove (320) is provided in the lower body so that the feed fluids can flow smoothly. As shown in FIG. 2C, feed fluids are introduced from two inlets (230a and 230b) with terminals that have nozzles so as to spray feed fluids. Also, the membrane of the present invention further comprises an inlet (230c) through which the third feed fluids are introduced from an upper body of the membrane module via a pressure reduction-eliminating feed pipe (122) to remove pressure reduction in the center of the membrane which generates by obliquely spraying feed fluids in a lower portion to influx with rotating.

The shape of the durable balls used in the membrane of the present invention is not specifically limited, but is preferably a complete spherical or elliptical form. The durable balls may be prepared from glass, silica or various plastics. In such cases, the durable balls have a hydraulic diameter of between 0.5 and 5 mm, preferably 4 mm, and the specific gravity thereof is in the range of 90 to 300%, preferably 150%, of that of feed fluids. Also, the effective volume fraction of durable balls used in the present invention is between 0.01 to 0.5, and preferably 0.12, wherein the effective volume fraction refers to the total volume of balls that occupy the space which is available to present beneath a block net screen.

Thus, according to the present invention, durable balls are inserted into a membrane module, so that the flow introduced within the module is converted into a vortex flow by hydraulic property of the flow and the vortex flow results in a fluctuation or rotation of the balls present within the module, which removes any concentration polarization or cake layers that form on the membrane surface. This maintains a permeation flux without impairing the quality of the permeate fluid. Further, the new plate-and-frame type membrane module with inserted durable balls using vortex flow according to the present invention is economically very advantageous since no additional apparatuses are required other than a block net screen to prevent the balls from being swept away, and said module substitutes conventional processes, by fluctuating or rotating balls present within a module by a means of rotating force of feed fluids introduced into a module.

The examples below illustrate the present invention in detail, but the invention is not limited to the scope thereof.

### EXAMPLE 1

The membrane module system of FIG. 1 was equipped with a single membrane module according to FIG. 2, and then the permeate flux and rejection of dextran were measured from 2,000 ppm of aqueous solution of dextran having molecular weight of 260,000. Polysulfone ultrafiltration having molecular weight cut-off of 300,000 was used as a plate-and-frame type membrane. The membrane module which inserted 500 glass balls having a diameter of 4 mm, a mean weight of 0.08 g and a specific gravity of 2.39 (239% of the specific gravity of feed fluids). The effective volume fraction of glass balls is 0.119. The experiment was performed at 1.6 atm of operating pressure and about 41/mim of flux of feed fluid at room temperature.

To compare an improvement in a permeate flux and rejection, this example was carried out for 1 hour in each of the cases using the same membrane modules, which are dead-end type without flowing, vortex flow type which is under vortex flow without glass balls, and balls-inserted type with vortex flow, respectively.

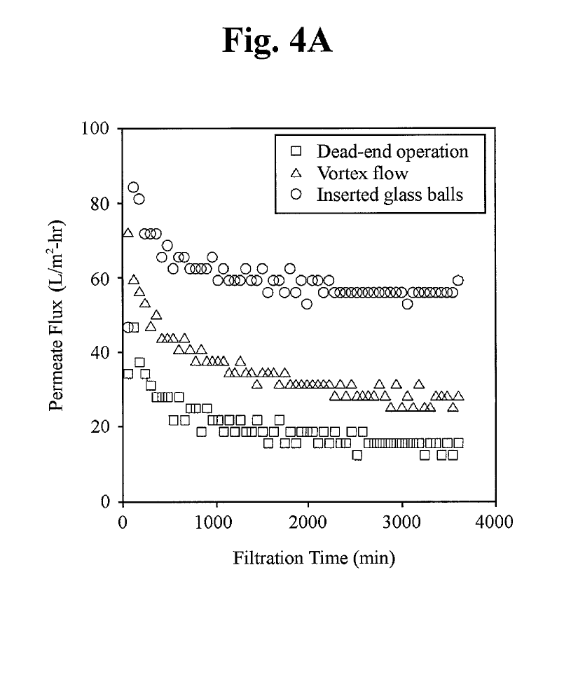

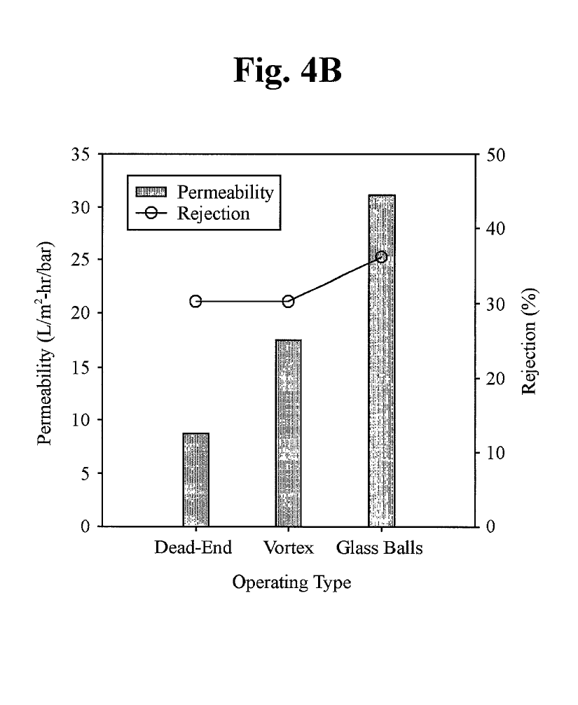

The comparative results are shown in FIG. 4A, which represents a change in the permeate flux of the filtration time; and FIG. 4B, which represents a rejection and permeability of the module types. Here, the concentration of feed fluids is a value that is obtained by measuring the turbidity of each concentration by means of a turbidimeter, which gives a turbidimeter calibration. Also, a rejection is obtained from the following formula:

(1−the concentration of permeate fluids/the concentration of feed fluids)×100, and a permeability is obtained from permeate flux/operating pressure.

As shown in this example, the case in which the glass balls are inserted has a permeate flux two time higher than that of the case without the inserted glass balls, and it has a permeate flux about three times higher than that of the dead-end type. Also, the rejection of the case in which the glass balls were inserted only slightly decreased compared with a dead-end type.

### EXAMPLE 2

This example carried out in the same manner as the process of Example 1, except that membrane system was equipped with single membrane module according to FIG. 2, with varying the number of balls to be inserted as 250, 500, 750, 1500. Tables 1 and 2 show effects of effective volume fraction of glass balls on a permeate flux and rejection, respectively.

Here, an effective volume fraction of glass balls was 0.059, 0119, 0.178 and 0.356, respectively. The permeate flux increased until the effective volume fraction was 0.119. Rejection has greatest value when the fraction was 0.059. Also, in cases where glass balls were not inserted (i.e., an effective volume fraction of 0), a permeate flux at 60 minutes after experiment decreased to a degree of about 40%, compared with 5 minutes after the experiment. However, in the case with glass balls inserted, a permeate flux decreased to less than 20% over most of filtration times, and thus it was possible to operate for a long time.

TABLE 1
Effect of Effective Volume Fraction of Glass Balls on
Permeate Flux (1/hr-m²)

| Effective Volume | Filtration Time (min) | | | | |
|---|---|---|---|---|---|
| Fraction of Balls | 5 | 10 | 20 | 40 | 60 |
| 0 | 46.78 | 40.54 | 34.30 | 28.07 | 28.07 |
| 0.059 | 53.01 | 49.90 | 46.78 | 49.90 | 43.66 |
| 0.119 | 71.73 | 65.49 | 59.25 | 58.13 | 59.25 |
| 0.178 | 65.49 | 56.13 | 53.01 | 49.90 | 53.01 |
| 0.356 | 68.61 | 59.25 | 58.13 | 53.01 | 56.13 |

TABLE 2
Change of Rejection on Effective Volume Fraction of Balls

| | | | | | |
|---|---|---|---|---|---|
| Effective Volume | 0 | 0.059 | 0.119 | 0.178 | 0.356 |
| Fraction of Balls | | | | | |
| Rejection | 30.19 | 43.22 | 36.11 | 28.42 | 29.54 |

### EXAMPLE 3

This example was carried out in the same manner as the process of Example 1, except that the membrane system was equipped with a single membrane module according to FIG. 2, wherein 500 balls were inserted, with a varied feed flow rate of 0, 2, 4, 5, 6 l/min respectively. Tables 3 and 4 show effects of feed flow rate on permeate flux (1/hr-m²) and rejection, respectively.

This example demonstrated that the more feed flow rate increased, the more a performance of the membrane module increased. Thus, not considering power costs, it is preferable to operate a membrane module at a high feed flow rate.

TABLE 3
Effect of Feed Flow Rate on Permeate Flux(1/hr-m²)

| Feed Flow Rate | Filtration Time (min) | | | | |
|---|---|---|---|---|---|
| (1/mim) | 5 | 10 | 20 | 40 | 60 |
| 0 | 31.19 | 28.07 | 18.71 | 15.59 | 14.03 |
| 2 | 65.49 | 53.01 | 43.66 | 34.30 | 28.07 |
| 4 | 71.73 | 65.49 | 59.25 | 58.13 | 59.25 |
| 5 | 74.84 | 68.61 | 65.49 | 68.61 | 68.61 |
| 6 | 84.20 | 77.96 | 74.84 | 71.73 | 68.61 |

TABLE 4
Change of Rejection on Feed Flow Rate

| | | | | | |
|---|---|---|---|---|---|
| Feed Flow Rate | 0 | 2 | 4 | 5 | 6 |
| Rejection | 30.12 | 41.06 | 43.22 | 40.26 | 40.26 |

### EXAMPLE 4

This Example carried out in the same manner as the process of Example 1, with the exception that it is equipped with a laminated membrane module in FIG. 3 as a membrane system of FIG. 1. This example used a laminated membrane module which laminated five unit module, where an effective volume fraction of glass balls inserted into each of unit modules was 0.119, and flow rate of feed solution introduced into each of unit modules was 3.5 to 4.5 l/min.

As a result, this example provided a similar result to glass balls inserted type of Example 1, and showed that integrated permeate flux of five of unit membrane module was about five times that a unit membrane module. Thus, it is possible to scale up a membrane of the present invention according to a treatment capacity and a capacity of feeding pump.

### COMPARATIVE Example 1 to 3

To compare an performance of plate-and-frame type membrane module in Examples 1 to 3 with inserted durable balls, this example carried out for 1 hour in each of cases using the same membrane module, except for dead-end type without flowing, vortex flow type which under vortex flow without glass balls, and balls-inserted type with vortex flow, respectively. The result showed as comparative data in Examples 1 to 3.

### EFFECTS OF THE INVENTION

The present invention is directed to a plate-and-frame type membrane module inserted durable balls using vortex flow, and the membrane module can reduce concentration polarization, cake or gel layer and membrane fouling which generally occur in processes using plate-and-frame type membrane. Therefore, the plate-and-frame type membrane module of the present invention is used to effectively separate and/or fractionate the highly concentrated solutions, in particular in the food and biological industry, and thus it can widely be applied, regardless of the type of membranes, such as reverse osmosis, ultrafiltration, microfiltration, etc.

What is claimed is:

1. A plate-and-frame type membrane module using vortex flow, comprising
a single membrane module,
a rotatory feed fluid pipe to rotate feed fluids, while introducing said fluids through two inlets provided on opposing sides at the bottom of the membrane module,
a plurality of durable balls which are inserted into the module to eliminate cake or concentration polarization layers formed on the membrane surface by fluctuating or rotating them by influx of rotated feed fluids from the inlet into the module,
a pressure reduction-eliminating feed fluid pipe to remove pressure reduction within the module which is generated by the rotation of the feed fluid, and
a block net screen which is provided in an intermediate portion of the module or near a outlet of a concentrated fluid so as to prevent from being swept away the durable balls.

2. The membrane module according to claim 1, wherein the above durable balls are selected from a group consisting of glass, silica and plastic.

3. The membrane module according to claim 2, wherein the above durable balls are a complete spherical or a elliptical form, have a hydraulic diameter of 0.5 to 5 mm and have a specific gravity of 90 to 300% of that of feed fluids.

4. The membrane module according to claim 3, wherein the above durable balls have an effective volume fraction of 0.01 to 0.5.

5. The membrane module according to claim 1, wherein further comprising inlet to introduce the third feed fluids from the upper of the module in order to remove pressure reduction inside the membrane module.

6. A plate-and-frame type membrane module using vortex flow, comprising
a laminated membrane module,
a rotatory feed fluid pipe to rotate feed fluids, while introducing said fluids through two inlets provided on opposing sides at the bottom of the membrane module,
a distributor to uniformly provide the feed fluids from the rotated feed fluids pipe to each of a unit modules,
a plurality of durable balls which are inserted into the module to eliminate cake or concentration polarization layers formed on the membrane surface by fluctuating or rotating them by influx of rotated feed fluids from the inlet into the module, and
a block net screen which is provided in an intermediate portion of the module or near a outlet of a concentrated fluid so as to prevent from being swept away the durable balls.

7. The membrane module according to claim 6, wherein the above durable balls are selected from a group consisting of glass, silica and plastic.

8. The membrane module according to claim 7, wherein the above durable balls are a complete spherical or a elliptical form, have a hydraulic diameter of 0.5 to 5 mm and have a specific gravity of 90 to 300% of that of feed fluids.

9. The membrane module according to claim 8, wherein the above durable balls have an effective volume fraction of 0.01 to 0.5.
